(19) United States
(12) Patent Application Publication
(10) Pub. No.: US 2013/0003963 A1
(43) Pub. Date: Jan. 3, 2013

(54) Thwarting Unauthorized Content Copying Using Media Tracking Code

(76) Inventors: Gyan Prakash, Beaverton, OR (US); Selim Aissi, Beaverton, OR (US); Guru Raj, Portland, OR (US); Ramesh Pendakur, Gaston, OR (US)

(21) Appl. No.: 13/175,521

(22) Filed: Jul. 1, 2011

(51) Int. Cl. G06F 21/24; H04L 9/28

(52) U.S. Cl. 380/28; 726/26

(57) ABSTRACT

Embodiments of techniques and systems for content protection and detection of protected media content are described. Visual tracking patterns may be displayed during rendering of protected media content that would be visible to a camcorder during recording. The visual tracking pattern may be placed in a background area or other less-active portion of the video in order to reduce perceptibility by a viewer. Audio tracking patterns may be inserted during rendering outside of the range of normal human hearing for reduced viewer perceptibility. The tracking patterns may encode media tracking codes that are included in to-be-rendered media during provision from a media server. Other embodiments may be described and claimed.

### TECHNICAL FIELD

This application relates to the technical field of data processing, more specifically to methods and apparatuses associated with thwarting unauthorized copying of rendered media.

### BACKGROUND

Digital media content piracy continues to be a critical issue for digital media content owners. Even though systems and techniques exist to prevent digital media copying, these systems and techniques do not necessarily provide an ability to defeat analog copying of the digital media content. This is true even for technologies that securely decode and render digital video and audio content in a protected audio/video path. Digital media content is particular vulnerable to piracy when after it is rendered on a display; this vulnerability is especially prevalent when using high-quality recording equipment. For example, in many circumstances a pirate may capture video content during rendering of the video content using a High Definition (HD) camcorder with multi-channel audio, or other recording device. When used in a theater or in another media environment using high rendering quality, a very effective copy may be made of the video content. The pirated video content thus made may then be distributed on the Internet or in other form, harming the video content-owner's ability to monetize the video content.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 is block diagram illustrating a protected content tracking system in accordance with various embodiments of the present disclosure;

FIG. 2 is a block diagram illustrating one example of components of a rendering device used in the protected content tracking system in accordance with various embodiments;

FIG. 3 illustrates an example media tracking process in accordance with various embodiments;

FIG. 4 illustrates an example tracking code generation process in accordance with various embodiments;

FIG. 5 illustrates an example media rendering process in accordance with various embodiments;

FIG. 6 illustrates an example media tracking pattern generation process in accordance with various embodiments;

FIG. 7 illustrates an example media tracking code detection process in accordance with various embodiments; and

FIG. 8 illustrates an example computing environment in accordance with various embodiments.

### DETAILED DESCRIPTION OF ILLUSTRATIVE EMBODIMENTS

Illustrative embodiments of the present invention include, but are not limited to, methods and apparatuses for protecting media content, such as video and/or audio content, by inserting visual and/or audio tracking patterns into the media content as that media content is rendered. In various embodiments, these tracking patterns may be displayed or played in the rendered media content such that they are visible and/or audible to a camcorder during recording, thereby providing a type of watermarking of the media content. In various embodiments, a visual tracking pattern may be placed in a background area or other less-active portion of the rendered media content in order to reduce perceptibility by a viewer. In other embodiments, an audio tracking pattern may be inserted during rendering; these audio tracking patterns may be placed outside of the range of normal human hearing for reduced listener perceptibility. In various embodiments, the visual and/or audio tracking patterns may encode one or more media tracking codes that may identify a user and/or the media being protected.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”.

As discussed above, systems, apparatuses and techniques described herein may include insertion of visual and audio tracking patterns into media content. In various embodiments, these visual and audio tracking patterns may encode information for one or more media tracking codes. In various embodiments, the media tracking codes may be recipient based, i.e., based at least in part on information that may identify the target recipients of the media, e.g., subscribers of the service providing the media. In various embodiments, after the media is provisioned to a rendering device, visual and/or audio tracking patterns may be generated at the rendering device based at least in part on media tracking codes provided by a media server along with the media. For example, a media server may generate media tracking codes based on user and/or media information and incorporate that media tracking code information to media content provided by the server upon request from a rendering device.

In alternative embodiments, the visual and audio tracking patterns may be generated at a media server in addition to the media tracking codes and included with encrypted media before provision to a rendering device. For example a media server may incorporate generated media tracking code information to media content as a visual and/or audio tracking pattern before the media content is provided to a rendering device to be viewed and/or heard.

The visual tracking patterns may be placed in unobtrusive or hard-to-detect locations in the media in order to reduce user perception of the patterns. For example, in some embodiments, visual tracking patterns may be placed in background images or other less-noticeable locations. Similarly, in some embodiments, audio tracking patterns may be placed in parts of the audio spectrum outside of normal human hearing.

During rendering, these visual and/or audio tracking patterns may be detected. For example, a camcorder recording a video as it is rendered may detect the presence of a visual and/or audio tracking pattern encoding a media tracking code. In another example, software which is rendering a movie file may detect the presence of a visual and/or audio tracking pattern. In various embodiments, the software or hardware performing the detection may then perform a security-based action, such as discontinuing recording of the media content or rendering of the media file. By detecting and taking action based on the presence of a visual and/or audio pattern encoding a media tracking code, the system decreases the likelihood that protected media will be pirated successfully.

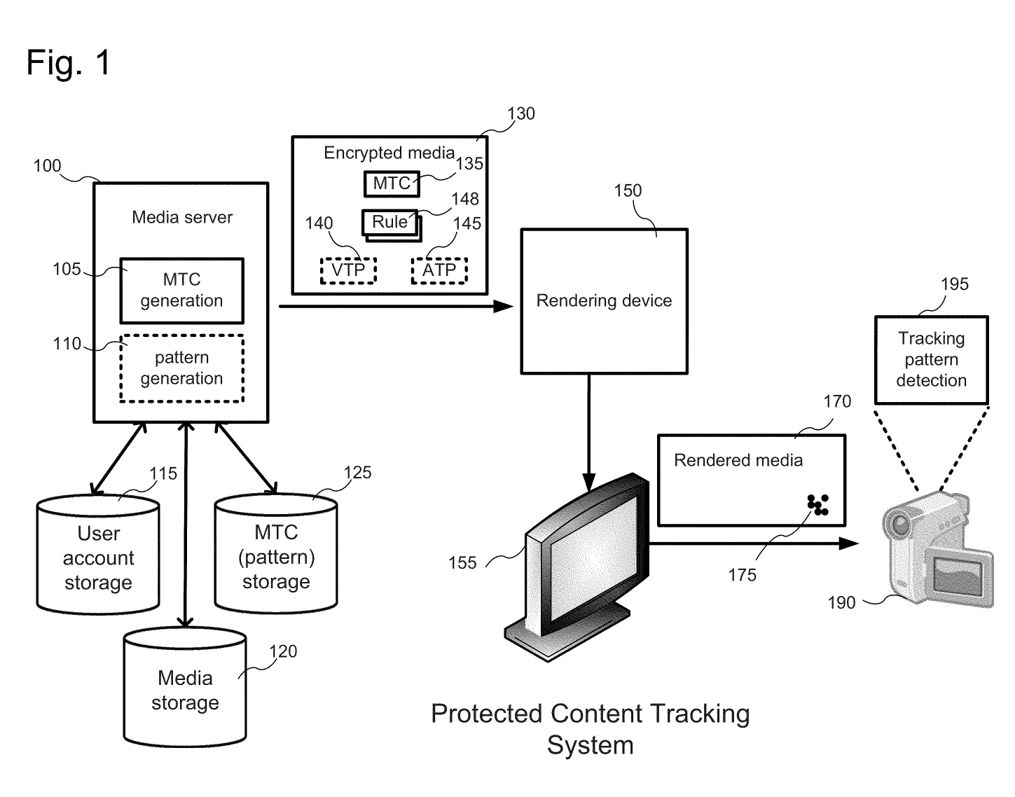

FIG. 1 is a block diagram illustrating a protected content tracking system in accordance with various embodiments of the present disclosure. As illustrated, in various embodiments, the protected content tracking system may include a media server 100, a rendering device 150, and a recording device 190, operatively coupled with each other as shown. In various embodiments, the media server 100 may include media tracking code (“MTC”) generation module 105 configured to generate media tracking codes for provisioned media. As discussed above, in various embodiments, the MTC generation module 105 may generate MTCs based on user information such as an identification of a user account. In some embodiments, MTCs may be based on content information as well, such as an identification of the particular media being provisioned. As described earlier, visual tracking patterns (“VTPs”) and/or audio tracking patterns (“ATPs”) may be generated, based on and/or encode MTCs, for use in thwarting unauthorized copying of the provisioned media. As will be described in more detail below, the VTPs and/or ATPs may be generated downstream by the rendering device. However, in some embodiments, the media server 100 may additionally include a pattern generation module 110 configured to generate the VTPs and/or ATPs for the downstream rendering device. In yet other embodiments, the MTCs may be generated (along with the VTP and ATP) at a rendering device rather than at the media server 100. The downstream generated MTCs may be communicated back to the media server 100 for storage and record-keeping.

In various embodiments, the media server 100 may provision encrypted media 130 to a rendering device 150. As earlier described, the encrypted media 130 may include an MTC 135, which may be generated by an MTC generation module 105 on media server 100. In alternative embodiments, the encrypted media 130 may additionally include an VTP 140 and/or an ATP 145, which may be generated by a pattern generation module 110 on media server 100. In such embodiments that include the VTP 140 and ATP 145 in the encrypted media 130, the rendering device 150 will not have to generate tracking patterns during rendering, and instead may use the VTP 140 and/or ATP 145 included in the encrypted media 130. In various embodiments, the MTC 135, VTP 140, and/or ATP 145, if included, may be encrypted for inclusion in the encrypted media 130. In various embodiments, the MTC 135, VTP 140, and/or ATP 145 may include a digital signature based on a user account associated with the provision of the encrypted media 130.

In various embodiments, the encrypted media may also include one or more protected content rule(s) 148, which provide information for trusted components on the rendering device 150 to use for decrypting and utilizing the encrypted media 130, the MTC 135, the VTP 140 and/or the ATP 145. In some embodiments, the protected content rule(s) 148 may include information as to how to include the MTC 135, VTP 140, and/or ATP 145 during rendering of the media. For example the protected content rule(s) may direct that an ATP (which is either included in the encrypted media 130 or generated by the rendering device 15) should be played in rendered video at a specific frequency.

In various embodiments, the media server 100 may interact with various storages which may maintain information to be used to provide visual and/or audio tracking codes for rendered media. For example, the media server 100 may interact with or otherwise include a media storage 120, which may maintain media files for provision, such as encrypted media 135. In various embodiments, the media files may be configured to be streamed to a rendering device 150 and/or to be downloaded as complete files. Hence, the encrypted media 130 may include a data stream or a downloaded file, depending on the particular scenario and/or configuration.

The media server 100 may also interact with a user account storage 115, which may maintain account information associated with users of media provided by the media server 100. For example, if a user is a subscriber to a streaming video service, the user account storage may maintain the user's subscriber information. The user account storage may also provide this account information to the media server 100 for the MTC generation module 105 to use when generating an MTC (which may likewise be used by the pattern generation module 110 to generate VTPs and/or ATPs by the pattern generation module 110). In various embodiments, the media server may also interact with MTC storage 125 in order to store and maintain MTCs for inclusion with encrypted media. In some embodiments, the MTC storage 125 may additionally store and maintain tracking patterns, such as VTPs and ATPs.

As described throughout the specification, the rendering device 150, in various embodiments, may be configured to receive the encrypted media 135 and render and display the encrypted media 135 as rendered media 170 on a display 155. In various embodiments, the rendering device 150 may include the display 155, such as in a television or laptop computer configured to perform techniques described herein. In other embodiments, the rendering device 150 may communicate with a display 155, such as a desktop computer connected to a monitor or a cable device, game console, or other A/V equipment connected to a TV.

The rendering device 150 may be configured to cause the rendered media 175 to include one or more VTPs and/or ATPs (which may be self-generated by the rendering device 150 or received by the rendering device 150), such as example pattern 175. For example, the rendering device 150 may include a TV or computer monitor having trusted components which are configured to decrypt encrypted media 130, decrypt an MTC 135 included in the encrypted media 130 under the direction of content rule(s) 148, and render the decrypted media to include VTPs and/or ATPs based on the MTC 135. In alternative embodiments, the rendering device 150 may be further configured to receive VTP 140 and/or ATP 145 in the encrypted media 130 and render the received VTP and/or ATP directly in the rendered media 170. In various embodiments, the rendering device may include other devices, such as home or cinema-style movie projectors, or computers or media players rendering on an associated display.

Accordingly, the rendered media 170 may be protected from recording, if recorded by a recording device 190, such as a camcorder or audio recorder, equipped with a tracking pattern detection module 195 configured to detect VTPs and/or ATPs. In various embodiments, tracking pattern detection module 195 may be implemented in software, hardware, or firmware. The tracking pattern detection module 195 may detect VTPs and/or ATPs, such as pattern 175, displayed (or played, in the case of audio) in the rendered media 170, and in response, take an appropriate security action, as will be discussed herein.

In some embodiments, the protection may be accorded through a subsequent rendering device configured to detect the tracking patterns during a subsequent rendering, instead. For example, if a protected video were to be rendered to include tracking patterns, but were recorded by a recording device that was not configured to detect the tracking pattern and stop the unauthorized recording, the resulting recorded video may be received and later rendered again by a device that includes the tracking pattern detection module 195, to thwart the consumption of the unauthorized copy. In this case, the security action may be performed by the device which is performing the later rendering of the recorded (and possibly pirated) video.

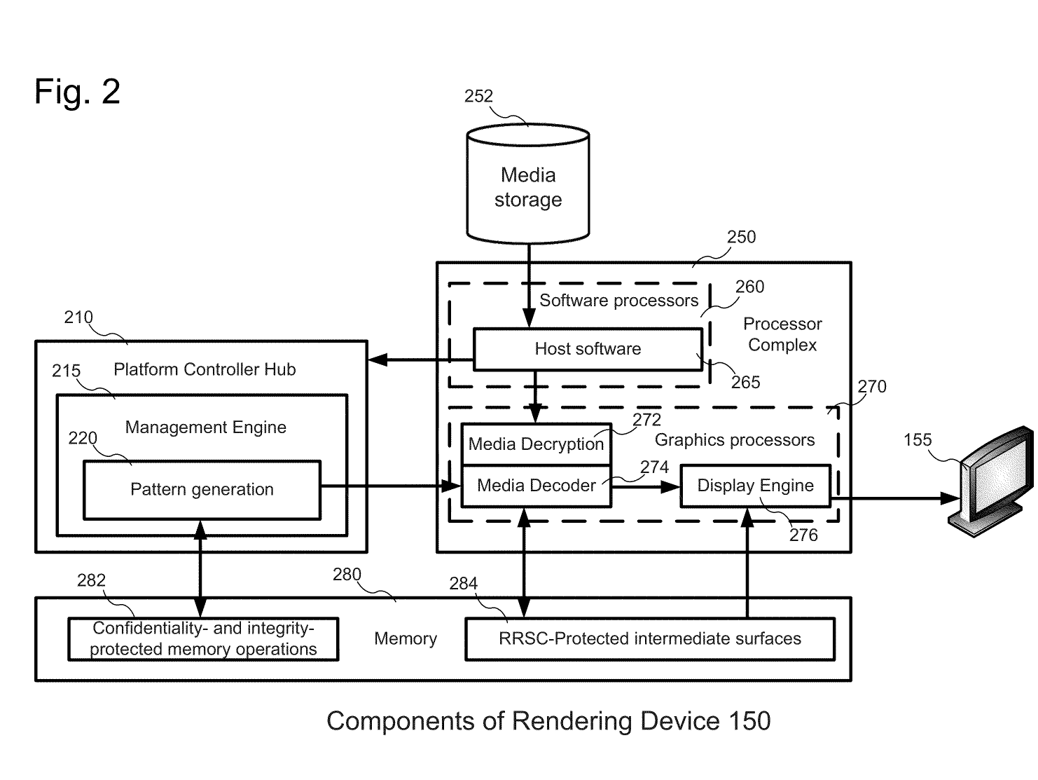

FIG. 2 is a block diagram illustrating one example of components of a rendering device 150 used in the protected content tracking system in accordance with various embodiments. While particular combinations of modules and hardware are illustrated, it may be recognized that, in various embodiments, different combinations may be used and particular features may be removed or divided further.

In various embodiments, the rendering device 150 may include a processor complex 250 and a platform controller hub 210 which interact with each other and with various other aspects of the rendering device 150 in order to render protected media using tracking patterns as described herein. The processor complex 250 may, in various embodiments, include one or more software processors 260 (such as, for example, one or more Intel architecture processors) and/or graphics processors 270 in order to perform rendering of protected media.

In various embodiments, the software processors may execute host software 265 which directs, at a high level, the rendering of protected media. In various embodiments, the host software may interact with a media storage 252 of the rendering device 150 in order to obtain encrypted media 130 for rendering. Once the encrypted media 130 has been obtained from the media storage, the host software 265 may provide it to the platform controller hub 210 for generation of VTPs and/or ATPs based on the MTC 135. The host software 265 may also, in various embodiments, provide the encrypted media to media decryption module 272 and media decoder 274, which may execute on the graphics processors 270.

The platform controller hub 210 may operate independently of the processor complex, such as to allow operations to be performed in the platform controller hub outside of view of operations in the processor complex 250. In particular, a management engine 215 may execute on the platform controller hub 210 in order to provide a secure execution environment for execution of trusted components. As FIG. 2 illustrates, in various embodiments, a pattern generation module 220 may operate in the management engine 215 in order to generate VTPs and/or ATPs. In other embodiments the pattern generation module 220 may also generate the MTC rather than receive the MTC with the encrypted media; in various such embodiments, the rendering device 150 may send a message to the media server 100 (or other media-provisioning portal) with the generated MTC information. In yet other embodiments, if the VTP and ATP are received in the encrypted media along with an MTC, the pattern generation module 220 may not be used to generate patterns.

In various embodiments, the pattern generation module 220 may store a received MTC and utilize the stored MTC to generate one or more VTPs and/or ATPs to be included in media as it is rendered. In some embodiments, the pattern generation module 220 may operate as part of Intel Media Vault technology in management engine 215; in other embodiments, other software, hardware, or firmware implementations may be used. In various embodiments, the pattern generation module 220, as well as the management engine 215 may operate using confidentiality- and integrity-protected memory operations 282 when interacting with a memory 280 in order to keep the information used by the pattern generation module 220 from being accessed by other executing software, such as the host software 265. In various embodiments, the generated patterns may include hashes, digital signatures, or other information for inclusion in the rendered video.

In various embodiments, when the VTP and/or ATP have been generated by the pattern generation module 220, the VTP and/or ATP may be sent to a media decoder 274 executing on the graphics processors 270. In some embodiments, the pattern generation module 220 may also instruct the media decoder 274 to perform insertion of the VTP and/or ATP. The VTP and/or ATP may be, in some embodiments, transmitted as part of a protected audio video path mechanism; thus the transmission may be performed independently of any operating system stacks on the rendering device 150.

Once the VTP and/or ATP have been received by the media decoder 274, the media decoder 274 may, in various embodiments, insert the VTP and/or ATP into the decoded media during rendering. As discussed herein, the insertion of the VTP and/or ATP may be performed such as to be as unobtrusive as possible on a viewer. For example, VTPs may be placed in background locations or other non-changing areas. The VTPs may be placed briefly in random frames or in various pixel locations on frames to prevent them from being readily noticed. In some embodiments, the VTPs may be inserted using colors which are similar to those colors which are already in the area in which the patterns are being inserted. In the case of ATPs, the patterns may be inserted outside of the normal range of human hearing. In various embodiments, the VTP may be distinguishable from other identifying information which is overlaid or otherwise introduced into video. For example, some broadcast and cable networks will insert a channel identifier, or “bug,” into a corner of the screen to visually display the identity of a channel being displayed. In various embodiments, the VTP may be utilized in place of or concurrently with such a channel identifier. In various embodiments, while the “bug” may be visible to a casual viewer, the VTP may not be, so as to avoid distraction by viewers.

In various embodiments, the media decoder 274 may then communicate the decoded and watermarked media to a display engine 276. In various embodiments, the media decoder 274 and display engine 276 may interact through RRSC-protected intermediate surfaces in the memory 280, which may be independent and protected from the previously-discussed memory operations 282. The display engine 276, after receiving the decoded and watermarked rendered media, may then output the media to a display 155 for viewing. In various embodiments, the display engine 276 may output to a integrated display (such as in the case of a television) or an attached display, such as from a media player over an HDMI or other video cable.

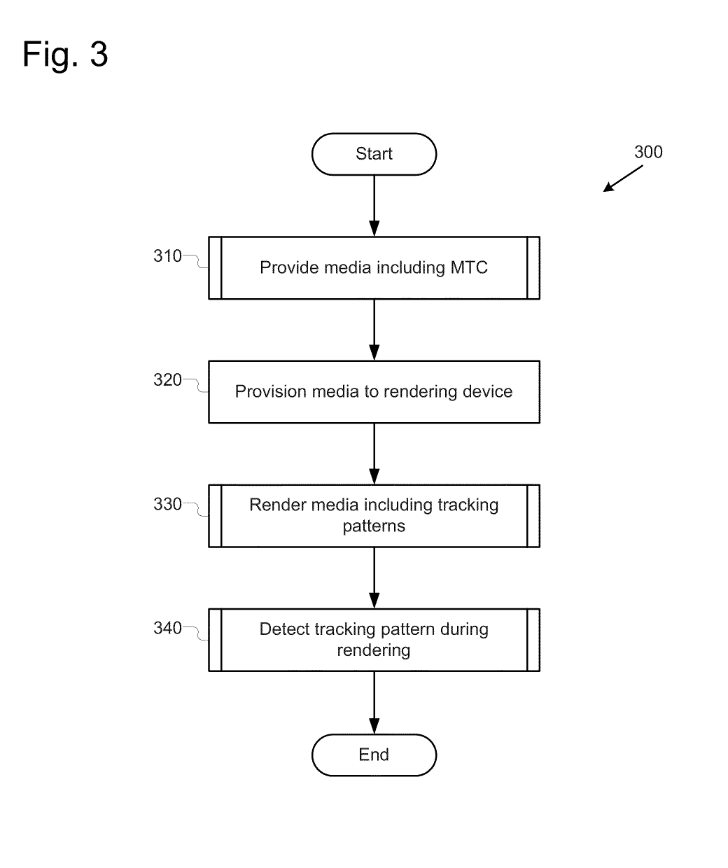

FIG. 3 illustrates an example media tracking process 300 in accordance with various embodiments. In various embodiments, one or more operations of process 300 may be reordered, removed, or split into further operations. The process may begin at operation 310, where, in various embodiments, the media server 100 may provide media including an MTC for receipt and rendering by a rendering device, such as rendering device 150. As discussed, in various embodiments, one or more VTPs and/or ATPs may also be included in the provided media. Particular examples of this operation are discussed below. At operation 320, in various embodiments, the media server 100 may provision the media to the rendering device. Next, at operation 330, in various embodiments the rendering device may render the provisioned media, including VTPs and/or ATPs based on the MTC. Particular examples of this operation are discussed below. After (concurrent with) rendering, in various embodiments a detecting device, such as a camcorder, may then detect the visual and/or audio tracking pattern during the rendering and take further action. Particular examples of this operation are discussed below. The process may then end.

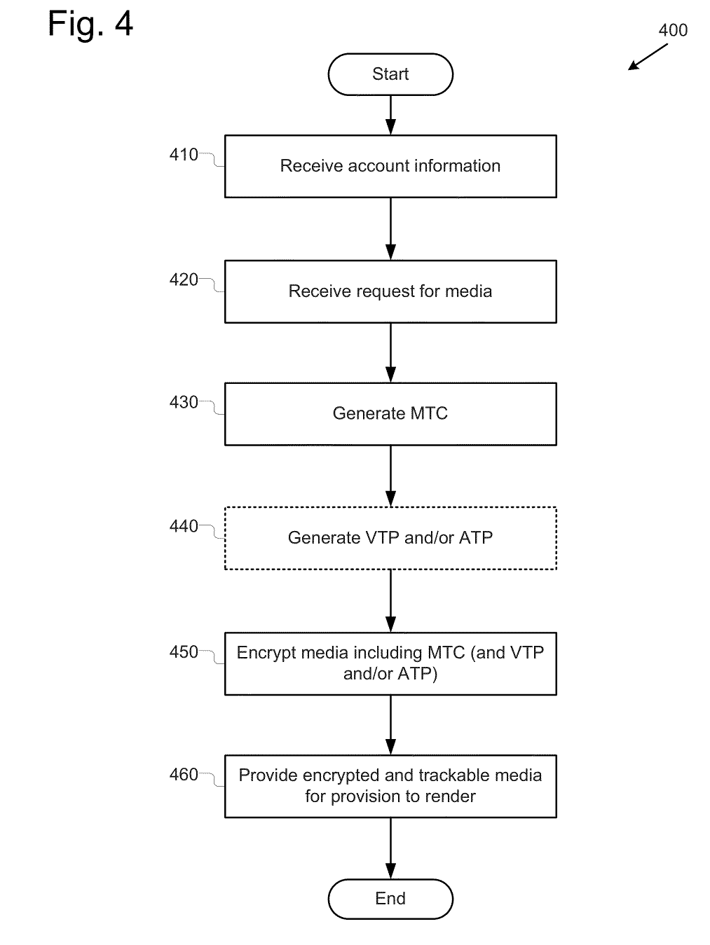

FIG. 4 illustrates an example tracking code generation process 400 in accordance with various embodiments. In various embodiments, process 400 may be performed by the media server 100. In various embodiments, one or more operations of process 400 may be reordered, removed, or split into further operations. In various embodiments, process 400 may provide an implementation of operation 310 of process 300.

The process may begin at operation 410, where the media server 100 may receive account information, such as for a user that wishes to receive and view media. In various embodiments, the user account information may include a user name, an account number, or other information which identifies the particular user. At operation 420, in various embodiments, the media server 100 may then receive a request to provision media, such as from the user for whom account information was previously received. This media may be stored by the media server 100, such as on media storage 115.

Next, at operation 430, the media server may generate an MTC. As discussed above, in various embodiments, the media server 100 may generate the MTC using the MTC generation module 105. In various embodiments, the generated MTC may be based, in whole or in part, on the received account information for the user. In various embodiments, the MTC may include a digital signature based on the previously-received user account information. At optional operation 440, the media server 100 may generate a VTP and/or ATP. As discussed above, in various embodiments, the media server 100 may generate the ATP using the pattern generation module 110. In various embodiments, the VTP and/or ATP may be generated to be inserted unobtrusively into the rendered media. In various embodiments, operation 440 may be omitted and the VTP and/or ATP may be generated by the rendering device based on the MTC. In yet other embodiments, neither the MTC nor the VTP or ATP may be generated by the media server and the MTC/VTP/ATP may instead be generated by the rendering device during rendering and provisioned back to the media server.

At operation 450, the media server 100 may encrypt the media, including the MTC, the VTP and/or ATP, if generated. In various operations, the media, and MTC, VTP and/or ATP, if included, may be encrypted such that they may only be decrypted by a trusted component, such as within the management engine 215. At operation 460, in various embodiments, the encrypted media may then be provisioned, such as over a network, to the rendering device. In some embodiments, the encrypted media may be provisioned to one or more intermediary devices on the network before being provisioned to the rendering device. Thereafter, the process may end, or be repeated for another media and/or rendering device. The network may, in various embodiments, span private and/or public networks (such as the Internet), and may be wired and/or wireless.

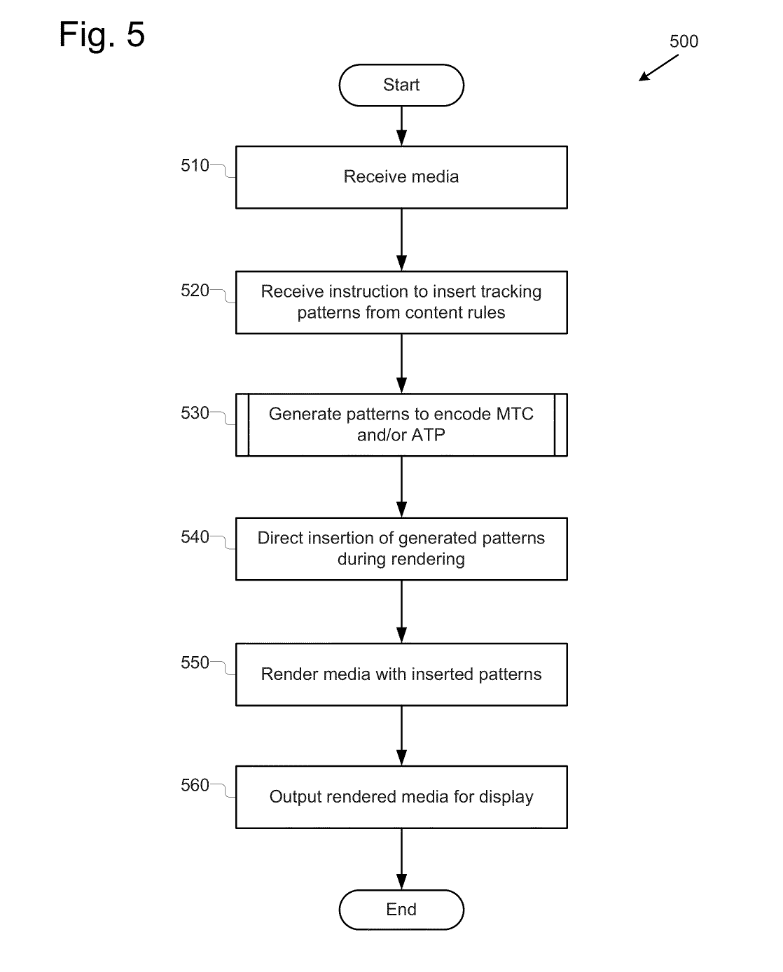

FIG. 5 illustrates an example media rendering process 500 in accordance with various embodiments. In various embodiments, process 500 may be performed by the rendering device 150. In various embodiments, one or more operations of process 500 may be reordered, removed, or split into further operations. In various embodiments, process 500 may provide an implementation of operation 330 of process 300.

The process may begin at operation 510, where the rendering device 150 may receive the encrypted media 130 containing the encrypted MTC 135 the VTP 140 and/or ATP 145, if included. At operation 520, the rendering device 150 may decode the content rules 148 from the encrypted media 130, and the MTC 135, VTPs and ATPs, if included. The rendering device 150 may further determine that VTPs and/or ATPs encoding the MTC 135 should be inserted into the rendered media. At operation 530, if not received, the pattern generation module 220 provided at the rendering device may then, generate the VTP and/or ATP to be inserted into the media during rendering. Particular implementations of this operation are described below. In alternative embodiments where the VTP and/or ATP have been received in the encrypted media, operation 530 may be omitted.

At operation 540, the rendering device 150 may, in various embodiments, direct insertion of the generated VTP and/or ATP during rendering. In various embodiments, the pattern generation module 220 may perform this direction. At operation 550, the rendering device 150 may render the media, including the insertion of the generated tracking patterns. In various embodiments, the rendering and insertion may be performed by one or more of the modules executing on the graphics processors 270, such as the media decryption module 272, the media decoding module 274, and/or the display engine 276. In various embodiments, as mentioned herein, the VTP and/or ATP may be inserted in such a way as to be unobtrusive to a viewer of the media. Then, at operation 560, the rendering device 150 may output the rendered media to a display, as discussed above.

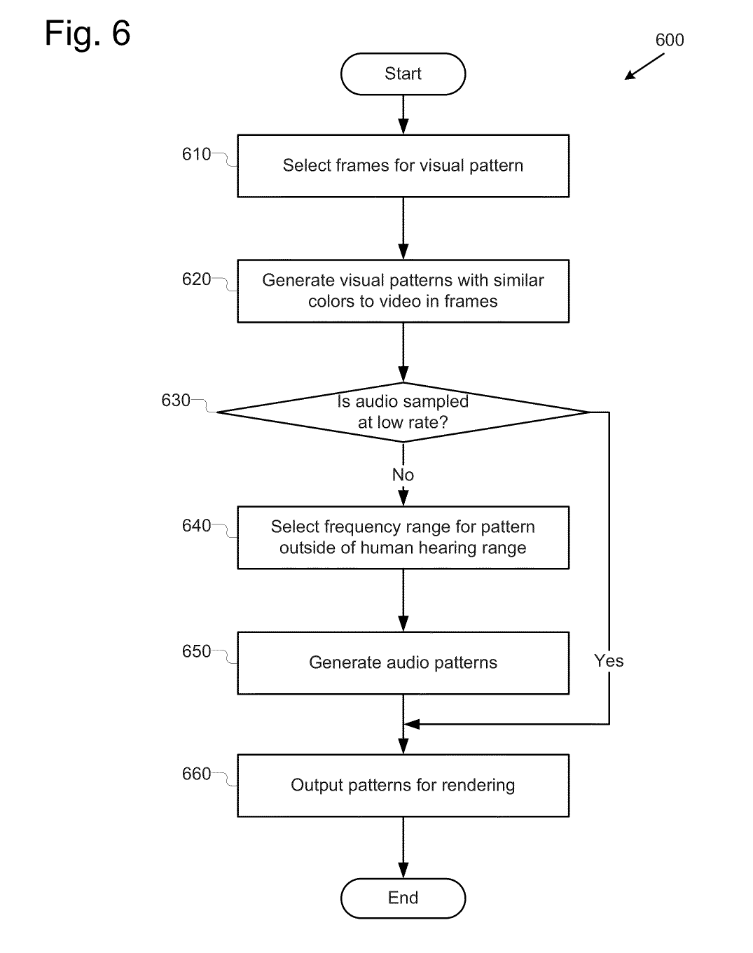

FIG. 6 illustrates an example media tracking pattern generation process 600 in accordance with various embodiments. In various embodiments, process 600 may be performed by the rendering device 150, and in particular by the pattern generation module 220. In various embodiments, one or more operations of process 600 may be reordered, removed, or split into further operations. In may be recognized in particular that, while the example process 600 shows generation of VTPs followed by generation of ATPs, in various embodiments either or both the types of tracking patterns may not be generated, and generation of the tracking patterns may be done in a different order or concurrently. Additionally, in some embodiments, the process may additionally include additional operations which are not illustrated, such as generation of an MTC, if none was received with encrypted media, followed by communication back to a provisioning media server of the generated MTC. In various embodiments, process 600 may provide an implementation of operation 530 of process 500.

The process may begin at operation 610, where, in various embodiments, the pattern generation module 220 may select one or more frames to have a VTP inserted during rendering. As discussed above, in various embodiments, the selection of frames may be done randomly and/or may be performed in order to select frames where tracking pattern insertion would be less likely to be noticed by a viewer. At operation 620, the pattern generation module 220 may, in various embodiments, generate VTPs with similar colors to colors in the selected frames.

At decision operation 630, the pattern generation module 220 may check the audio sampling rate for the media to be rendered to determine if it is worthwhile to generate and insert an audio tracking pattern into the rendered media. For example, in scenarios where the media has a low sampling rate, the audio may not be of a high-enough quality to require protection. Thus, if decision operation 630 determines that the audio is sampled at a low rate, then the process continues to operation 660, where the pattern generation module 220 may output the generated VTPs for insertion into the rendered media.

If, however, the pattern generation module 220 determines that the audio is sampled at a high-enough rate, then at operation 640, the pattern generation module 220 may select a frequency range for the ATP which is outside of normal human hearing. Then, at operation 650, the ATP is generated for insertion into the rendered media. Next, at operation 660, the pattern generation module 220 may output the generated VTPs and/or ATPs for insertion into the rendered media. The process may then end.

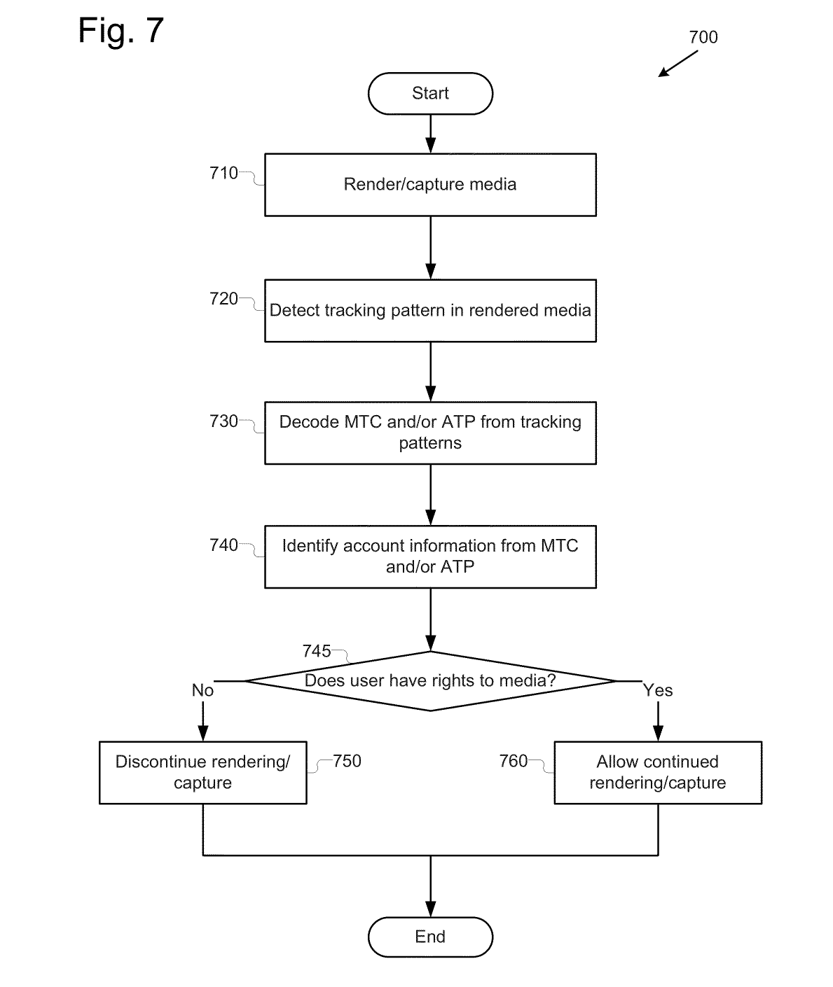

FIG. 7 illustrates an example media tracking code detection process 700 in accordance with various embodiments. In various embodiments, operations of process 600 may be performed by the recording device 190 (or other detecting device), and in particular by the tracking pattern detection module 195. In various embodiments, one or more operations of process 700 may be reordered, removed, or split into further operations. In various embodiments, process 700 may provide an implementation of operation 340 of process 300.

The process may begin at operation 710, where the protected media may be captured by the recording device 190. In some embodiments, rather than capturing video rendered by another device, the device 190 may re-render video which was previously recorded. At operation 720, the device may, in various embodiments, detect the presence of one or more visual and/or audio tracking patterns in the rendered media. At operation 730, the device may then, in various embodiments, decode the detected tracking patterns to determine the encoded MTC. Then, at operation 740, the device may identify account information based on the decoded MTC. In some embodiments, the device may directly receive the account information from the MTC. In other embodiments, the device may perform a lookup using the account information, such as by requesting information from the media server 100.

At decision operation 745, the device may determine if the user has rights to the rendered media. If the user does not have rights, then at operation 750, the device may discontinue the rendering or capture of the media. Thus, if video media is being recorded by a video recorder, the video recorder may cease recording; likewise if audio is being recorded, an audio recorder may cease recording. In another example, if the protected media is being rendered on a display, the display may abort rendering of the protected media. If, however, the user does have rights, then at operation 760, the device may allow the continued rendering or capture of the media. The process may then end.

In various embodiments, the detection and security action operations of process 700 may be different. For example, in some embodiments, if any tracking code is detected, the device may immediately cease capture or rendering on the assumption that the media has been pirated. In other embodiments, the device may provide a warning to a user of the device when the capture or rendering of the media is not allowed. In still other embodiments, the device may send a report, such as to the content owner, that the device detected pirated media.

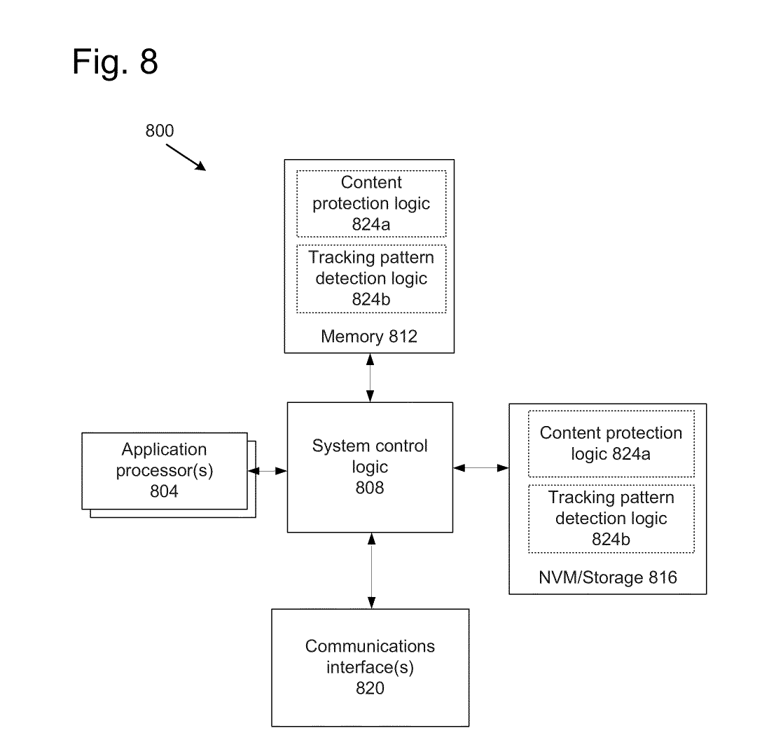

The techniques and apparatuses described herein may be implemented into a system using suitable hardware, firmware, and/or software to configure as desired. FIG. 8 illustrates, for one embodiment, an example system 800 including at least processors 804, system control logic 808 coupled to at least one of the processors 804, memory 812 coupled to system control logic 808, non-volatile memory (NVM)/storage 816 coupled to system control logic 808, and one or more communications interface(s) 820 coupled to system control logic 808. In various embodiments, the system 800 may include components of a CPU-based software system, a management engine system, or a combination of the two.

System control logic 808 for one embodiment may include any suitable interface controllers to provide for any suitable interface to at least one of the processors 804 and/or to any suitable device or component in communication with system control logic 808. The processors may include a dedicated application processor upon which an application environment may be operated, as well as a separate service processor upon which a manageability engine may be operated. The system may include additional processors or processing cores (not illustrated).

System control logic 808 for one embodiment may include one or more memory controller(s) to provide an interface to memory 812. System memory 812 may be used to load and store data and/or instructions, for example, for system 800. System memory 812 for one embodiment may include any suitable volatile memory, such as suitable dynamic random access memory (DRAM), for example.

System control logic 808 for one embodiment may include one or more input/output (I/O) controller(s) to provide an interface to NVM/storage 616 and communications interface(s) 820.

NVM/storage 816 may be used to store data and/or instructions, for example. NVM/storage 816 may include any suitable non-volatile memory, such as flash memory, for example, and/or may include any suitable non-volatile storage device(s), such as one or more hard disk drive(s) (HDD(s)), one or more solid-state drive(s), one or more compact disc (CD) drive(s), and/or one or more digital versatile disc (DVD) drive(s), for example.

The NVM/storage 816 may include a storage resource physically part of a device on which the system 800 is installed or it may be accessible by, but not necessarily a part of, the device. For example, the NVM/storage 816 may be accessed over a network via the communications interface(s) 820.

Memory 812 and NVM/storage 816 may include, in particular, temporal and persistent copies of logic, respectively. In the illustrated example, this logic may include either both content protection logic 824a or tracking pattern detection logic 824b. The content protection logic 824a or tracking pattern detection logic 824b may include instructions that, when executed by at least one of the processors 804, result in the system 800 performing content protection or detection operations as described in conjunction with the modules described herein. In some embodiments, the content protection logic 824a or tracking pattern detection logic 824b may additionally/alternatively be located in the system control logic 808.

Communications interface(s) 820 may provide an interface for system 800 to communicate over one or more network(s) and/or with any other suitable device. Communications interface(s) 820 may include any suitable hardware and/or firmware. Communications interface(s) 820 for one embodiment may include, for example, a network adapter, a wireless network adapter, a telephone modem, and/or a wireless modem. For wireless communications, communications interface(s) 820 for one embodiment may use one or more antenna(s).

For one embodiment, at least one of the processor(s) 804 may be packaged together with logic for one or more controller(s) of system control logic 808. For one embodiment, at least one of the processor(s) 804 may be packaged together with logic for one or more controllers of system control logic 808 to form a System in Package (SiP). For one embodiment, at least one of the processor(s) 804 may be integrated on the same die with logic for one or more controller(s) of system control logic 808. For one embodiment, at least one of the processor(s) 804 may be integrated on the same die with logic for one or more controller(s) of system control logic 808 to form a System on Chip (SoC).

In various embodiments, system 800 may have more or less components, and/or different architectures.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure. This application is intended to cover any adaptations or variations of the embodiments discussed herein. Therefore, it is manifestly intended that the embodiments of the present disclosure be limited only by the claims and the equivalents thereof.

1. A computer-implemented method comprising:
creating, by a computing device, a media tracking code (MTC) based at least in part on a media subscriber account identifier;
encrypting, by the computing device, the MTC;
including, by the computing device, the encrypted MTC with a media; and
providing, by the computing device, the media having the encrypted MTC to a client device for rendering, wherein the client device is configured to extract, decrypt and recover the MTC, and use the MTC to generate and insert a visual watermark in the rendered media to thwart unauthorized copying of rendered media.

2. The method of claim 1, further comprising generating, by the computing device, one or tracking patterns based on the MTC;
wherein encrypting further comprises encrypting the tracking patterns;
wherein including further comprises including the encrypted tracking patterns with the media;
wherein providing comprises providing the media having the encrypted MTC and the encrypted tracking patterns to a client device; and
wherein the client device is further configured to extract, decrypt and recover the tracking patterns, and use the tracking patterns to insert visual and/or audio watermarks in the rendered media to further thwart unauthorized copying of the rendered media.

3. The method of claim 2, wherein including further comprises including one or more rules in the media which direct the client device to insert the visual and/or audio watermarks in the rendered media.

4. The method of claim 1, wherein creating further comprises creating the MTC based at least in part on an identity of the media.

5. An apparatus comprising:
a processor arrangement configured to execute an operating system, and media applications under control of the operating system, wherein the processor arrangement includes a media engine configured to render media for the media applications; and
a management engine coupled with the processor arrangement, and configured to manage the apparatus independently of the operating system, wherein the management engine is further configured to generate tracking patterns for one or more tracking codes of a media for insertion into the media when rendered by the media engine.

6. The apparatus of claim 3, wherein the management engine is configured to generate one or more visual tracking patterns.

7. The apparatus of claim 6, wherein the media engine is configured to insert the one or more visual tracking patterns into a plurality of pixel locations in colors similar to colors of the pixel locations.

8. The apparatus of claim 6, wherein the management engine is further configured to direct the media engine to insert the one or more visual tracking patterns in different two-dimensional locations in different frames of the media.

9. The apparatus of claim 3, wherein the management engine is configured to generate one or more audio tracking patterns.

10. The apparatus of claim 9, wherein the management engine is configured to conditionally generate the audio tracking patterns only for audio in the media which has a sampling rate above a threshold.

11. The apparatus of claim 9, wherein the management engine is configured to generate audio tracking patterns outside of a frequency range substantially discernable by human hearing.

12. The apparatus of claim 3, wherein the management engine is further configured to decrypt one or more content rules contained in the media, the content rules specifying the one or more tracking codes.

13. The apparatus of claim 3, wherein the management engine is further configured to direct the media engine to insert the generated tracking pattern for the one or more tracking codes into the media being rendered.

14. The apparatus of claim 13, wherein the management engine is further configured to direct the media engine to insert the generated tracking patterns for the one or more tracking codes into one or more, but not all, frames of the media being rendered.

15. A computer-implemented method comprising:
generating, in a management engine on a computing device, one or more tracking patterns representing one or more tracking codes for insertion into a media being rendered by a media engine of a processor arrangement of the computing device, the media being rendered for a media application being executed under control of an operating system by the processor arrangement, wherein the management engine manages the computing device independent of the operating system; and
directing, by the management engine, the media engine on inserting the generated tracking patterns into the media being rendered.

16. The method of claim 15, wherein generating one or more tracking patterns comprises generating visual patterns.

17. The method of claim 16, further comprising the media engine inserting the generated the visual tracking patterns into a number of pixel locations in color similar to colors of the pixel locations.

18. The method of claim 16, wherein directing the graphics engine comprises directing the media engine to insert the visual tracking patterns in different respective portions of one or more respective frames of the media.

19. The method of claim 15, wherein generating one or more tracking patterns comprises generating audio patterns.

20. The method of claim 19, wherein generating audio tracking patterns comprises generating audio patterns at ranges substantially outside of human hearing.

21. The method of claim 19, wherein generating audio tracking patterns comprises generating audio tracking patterns only if audio information for the video content has a sampling rate above a pre-determined threshold.

22. The method of claim 15, wherein directing the graphics engine comprises directing the media engine to include the tracking patterns in fewer than all frames contained in the media.

23. The method of claim 15, wherein directing the graphics engine comprises directing the media engine to include the tracking patterns in the media in a substantially random manner.

24. The method of claim 15, further comprising decoding, by the management engine, one or more rules encoded in the media which direct the management engine to generate the tracking patterns for inclusion in the rendered media.

25. A computer-implemented method comprising:
detecting, by a media device, one or more encoded tracking patterns of a tracking code in a media, while capturing or rendering the media, wherein the tracking code is based at least in part on a media subscriber account identifier; and
in response to detection of one or more instances of the one or more tracking codes, the media device taking a security action associated with the capturing or rendering of the media.

26. The method of claim 23 further comprising decoding the one or more encoded tracking patterns to recover the tracking code to identify the media subscriber account.

27. The method of claim 23, wherein:
the media device comprises a video recorder;
detecting comprises detecting one or more encoded instances of one or more visual tracking codes; and
the security action comprises aborting the capturing of the media.

28. The method of claim 23, wherein:
the media device comprises an audio recorder;
detecting comprises detecting for one or more encoded instances of one or more audio tracking codes; and
the security action comprises aborting the capturing of the media.

29. The method of claim 23, wherein the media device is connected to a display and the security action comprises discontinuing display of the rendered media on the display.

30. An apparatus comprising:
a processor arrangement;
a media tracking code (MTC) generation module configured to be executed by the processor arrangement to create a media tracking code (MTC) based at least in part on a media subscriber account identifier; and
media provisioning logic configured to be executed by the processor arrangement to:
encrypt the MTC;
include the encrypted MTC with a media; and
provide the media having the encrypted MTC to a client device for rendering, wherein the client device is configured to extract, decrypt and recover the MTC, and to use the MTC to generate and insert a visual watermark in rendered media to thwart unauthorized copying of the rendered media.

31. The apparatus of claim 30, further comprising a pattern generation module configured to be executed by the processor arrangement to generate one or tracking patterns based on the MTC; and
wherein:
the media provisioning logic is further configured to encrypt the tracking patterns and include the encrypted tracking patterns with the media and to provide the media having the encrypted MTC and the encrypted tracking patterns to the client device; and
the client device is further configured to extract, decrypt and recover the tracking patterns, and to use the tracking patterns to insert visual and/or audio watermarks in the rendered media to further thwart unauthorized copying of the rendered media.

32. An apparatus, comprising:
a computing processor; and
a tracking pattern detection module configured to be executed by the computing processor to:
detect one or more encoded tracking patterns of a tracking code in a media during capture or render of the media, wherein the tracking code is based at least in part on a media subscriber account identifier; and
in response to detection of one or more instances of the one or more tracking codes, take a security action associated with the capture or render of the media.

33. The apparatus of claim 32, wherein:
the apparatus comprises a video or audio recorder;
the tracking pattern detection module is configured to:
detect one or more encoded tracking patterns through detection of one or more encoded instances of one or more visual or audio tracking codes; and
take a security action through abortion of the capture of the media.

34. One or more computer-readable storage devices containing instructions that, when executed on a computing device, cause the computing device to:
create a media tracking code (MTC) based at least in part on a media subscriber account identifier;
encrypt the MTC;
include the encrypted MTC with a media; and
provide the media having the encrypted MTC to a client device for rendering, wherein the client device is configured to extract, decrypt and recover the MTC, and use the MTC to generate and insert a visual watermark in rendered media to thwart unauthorized copying of the rendered media.

35. The computer-readable storage device(s) of claim 34, wherein:
encrypt further comprises encrypt the tracking patterns;
include further comprises include the encrypted tracking patterns with the media;
provide comprises provide the media having the encrypted MTC and the encrypted tracking patterns to a client device; and
the client device is further configured to extract, decrypt and recover the tracking patterns, and use the tracking patterns to insert visual and/or audio watermarks in the rendered media to further thwart unauthorized copying of the rendered media.

36. The computer-readable storage device(s) of claim 35, wherein include further comprises include one or more rules in the media which direct the client device to insert the visual and/or audio watermarks in the rendered media.

37. One or more computer-readable storage devices containing instructions that, when executed on a computing device, cause the computing device to:
generate, in a management engine on the computing device, one or more tracking patterns representing one or more tracking codes for insertion into a media being rendered by a media engine of a processor arrangement of the computing device, the media being rendered for a media application being executed under control of an operating system by the processor arrangement, wherein the management engine manages the computing device independent of the operating system; and
direct, in the management engine, the media engine on inserting the generated tracking patterns into the media being rendered.

38. The computer-readable storage device(s) of claim 37, wherein the operations further comprise decoding, in the management engine, one or more rules encoded in the media which direct the management engine to generate the tracking patterns for inclusion in the rendered media.

39. One or more computer-readable storage devices containing instructions that, when executed on a computing device, cause the computing device to:
detect one or more encoded tracking patterns of a tracking code in a media, during capture or render the media, wherein the tracking code is based at least in part on a media subscriber account identifier; and
in response to detection of one or more instances of the one or more tracking codes, taking a security action associated with the capture or render of the media.

40. The computer-readable storage device(s) of claim 37, wherein:
detect comprises detect one or more encoded tracking patterns through detection of one or more encoded instances of one or more visual or audio tracking codes; and
the security action comprises abortion of the capture of the media.

41. One or more computer-readable storage devices containing encrypted media, the encrypted media being prepared by a process comprising:
creating a media tracking code (MTC) based at least in part on a media subscriber account identifier;
encrypting the MTC;
encrypting the media; and
including the encrypted MTC with the encrypted media; and
wherein the encrypted media is configures such that, when the encrypted media is provided to a client device, the encrypted media facilitates the client device in extracting, decrypting, and recovering the MTC, and in using the MTC to generate and insert a visual watermark in the rendered media to thwart unauthorized copying of the rendered media.
